(19) United States
(12) Patent Application Publication
(10) Pub. No.: US 2007/0024836 A1
(43) Pub. Date: Feb. 1, 2007

(54) ILLUMINATION SYSTEM FOR A MICROLITHOGRAPHIC PROJECTION EXPOSURE APPARATUS

(75) Inventors: Wolfgang Singer, Aalen (DE); Johannes Wangler, Koenigsbronn (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/460,644

(22) Filed: Jul. 28, 2006

Related U.S. Application Data
(63) Continuation of application No. PCT/EP04/01129, filed on Feb. 7, 2004.

(51) Int. Cl. G03B 27/54

(52) U.S. Cl. 355/67; 355/53

(57) ABSTRACT

An Illumination system for a microlithographic projection exposure apparatus has a light source and a first optical raster element that is positioned in or in close proximity to a first plane. The first plane is conjugated to a pupil plane of the illumination system by Fourier transformation. A second optical raster element is positioned in or in close proximity to the pupil plane. A third optical raster element is positioned in or in close proximity to a second plane that is also conjugated to the pupil plane by Fourier transformation. The third optical raster element, which can be a diffractive optical element, introduces an additional degree of design freedom for the modification of the angular distribution of the projection light bundle.

### CROSS-REFERENCE TO RELATED APPLICATIONS

This is a continuation of International Patent Application PCT/EP2004/001129, which was filed on Feb. 7, 2004. The full disclosure of this earlier application is incorporated herein by reference.

### BACKGROUND OF THE INVENTION

1. Field of the Invention

The invention relates generally to illumination systems for microlithographic projection exposure apparatus. More particularly, the invention relates to illumination systems comprising diffractive or other raster optical elements for manipulating the angular distribution of projection light produced by the illumination system.

2. Description of Related Art

Microlithography (also called photolithography) is a technology for the fabrication of integrated circuits, liquid crystal displays and other microstructured devices. More particularly, the process of microlithography, in conjunction with the process of etching, is used to pattern features in thin film stacks that have been formed on a substrate, for example a silicon wafer. At each layer of the fabrication, the wafer is first coated with a photoresist which is a material that is sensitive to radiation, such as deep ultraviolet (DUV) light. Next, the wafer with the photoresist on top is exposed to projection light through a reticle (also referred to as a mask) in a projection exposure apparatus, such as a step-and-scan tool. The reticle contains a circuit pattern to be projected onto the photoresist. After exposure the photoresist is developed to produce an image corresponding to the circuit pattern contained in the reticle. Then an etch process transfers the circuit pattern into the thin film stacks on the wafer. Finally, the photoresist is removed.

A projection exposure apparatus typically includes an illumination system, a projection lens and a wafer alignment stage for aligning the wafer coated with the photoresist. The illumination system illuminates a region of the reticle with an illumination field that may have the shape of an elongated rectangular slit. As the technology for manufacturing microstructured devices advances, there are ever increasing demands also on the illumination system. For example, there is a need to illuminate the reticle with an illumination field having uniform irradiance.

Another important property of illumination systems is the ability to manipulate the angular distribution of the projection light bundle that is directed onto the reticle. In more sophisticated illumination systems it is possible to adapt the angular distribution of the projection light to the kind of pattern to be projected onto the reticle. For example, relatively large sized features may require a different angular distribution than small sized features. The most commonly used angular distributions of projection light are referred to as conventional, annular, dipole and quadrupole illumination settings. These terms refer to the intensity distribution in a pupil plane of the illumination system. With an annular illumination setting, for example, only an annular region is illuminated in the pupil plane, and thus there is only a small range of angles present in the angular distribution of the projection light so that all light beams impinge obliquely with similar angles onto the reticle.

Since lasers are typically used as light sources in illumination systems, the projection light bundle emitted by the light source has usually a small cross section and a low divergence. Therefore the geometrical optical flux, which is also referred to as the light conductance value, is small. Since the geometrical optical flux is not altered when a light bundle traverses an interface between media having different refractive indices, the geometrical optical flux cannot be changed by conventional refractive optical elements such as lenses.

Therefore most illumination systems contain optical elements that increase, for each point on the element, the divergence of light passing this point. Optical elements having this property will in the following be generally referred to as optical raster elements.

From U.S. Pat. No. 6,295,443 an illumination system is known in which a first optical raster element is positioned in an object plane of an objective within the illumination system. A second optical raster element is positioned in an exit pupil plane of the objective. As a result of this arrangement, the first optical raster element determines the intensity distribution in the exit pupil plane and therefore modifies the angular distribution of light. At the same time the geometrical optical flux of the projection light is increased. The second optical raster element modifies the size and geometry of the illuminated field on the reticle and also increases the geometrical optical flux of the projection light bundle. Zoom optics and an axicon lens pair allow to modify the intensity distribution in the pupil plane and therefore the angular distribution of the projection light bundle.

From EP 1 211 651 A1 an illumination system is known in which projection light emitted by a laser passes a diffractive element, a first fly's eye lense positioned in a field plane and finally a second fly's eye lense positioned in a pupil plane.

### SUMMARY OF THE INVENTION

It is an object of the present invention to provide an illumination system having increased flexibility with respect to the setting of various illumination parameters and particularly of the angular distribution of the projection light bundle.

This object is achieved by an illumination system for a microlithographic projection apparatus comprising a light source, a first optical raster element positioned in or in close proximity to a first plane that is conjugated to a pupil plane of the illumination system by Fourier transformation, and a second optical raster element positioned in or in close proximity to the pupil plane. A third optical raster element is positioned in or in close proximity to a second plane conjugated to the pupil plane by Fourier transformation.

The third optical raster element is thus positioned in a field plane of the illumination system and introduces a new degree of design freedom for the modification of the angular distribution of the projection light bundle. Further, since there are three optical raster elements, the geometrical optical flux is increased in three steps instead of only two steps. This considerably simplifies the design of all optical elements that are located, if viewed along the optical axis, in front of the third optical raster element.

Apart from that, the third optical raster element situated in a field plane allows to modify the angular distribution of light separately for each point in the illumination field. This means that different illumination settings can be applied to different areas on the reticle to be projected onto the wafer.

Since the resulting angular distribution of the light bundle that impinges on the reticle may be described as a convolution of the intensity distributions generated by the first and the third optical raster elements in pupil planes, the angular distribution may be improved in many respects. For example, since most optical raster elements illuminate, due to their raster structure, the pupil plane not uniformly but only in the form of separated segments, a third optical raster element in the form of a frosted glass plate or a similar scattering plate can smooth the transitions between contiguous illuminated segments in the pupil plane.

Each of the optical raster elements may be configured, as non-restricting examples, as a two-dimensional arrangement of diffractive structures, an array of refractive microlenses or an array of phase-step or grey-tone Fresnel lenses. Further examples for possible configurations for optical raster elements are described in U.S. Pat. No. 6,285,443 whose contents is fully incorporated herein by reference. The optical raster elements should be positioned as close as possible to the first plane, the pupil plane and the second plane, respectively. However, often other optical elements have to be arranged or in close proximity to these planes. Therefore it may be necessary to shift the optical raster elements slightly along the optical axis out of the ideal position within the planes. Slight deviations from this ideal position, however, often do not significantly deteriorate the function of the optical raster elements. The amount by which the optical raster elements may be shifted in this manner without intolerably deteriorating the optical properties thereof depend on the specific layout of the illumination system and, more particularly, its numerical aperture.

The first optical raster element may be positioned in or in close proximity to an object plane of a first objective, and a second optical raster element may be positioned in or in close proximity to an exit pupil plane of the first objective. The second optical raster element may then be positioned in or in close proximity to an entrance pupil plane of a second objective, and the third optical raster element may be positioned in or in close proximity to an image plane of the second objective. The term “objective” is used in this context to denote any single optical element or combination of optical elements constituting an imaging optical system.

The first objective may comprise an optical zoom unit for changing the size of an intensity distribution in the pupil plane generated by the first optical raster element. Additionally or instead, the first objective may comprise a pair of axicon lenses which is particularly useful for generating an annular illumination setting.

In a preferred embodiment a holder is provided for interchangeably holding the first and/or the third optical raster element. This allows to easily interchange raster elements and therefore to modify the angular distribution of the projection light bundle.

In another preferred embodiment the third optical raster element comprises a plurality of optical sub-elements, for example diffraction structures, having a non-uniform distribution over an area of the raster element. Such an optical raster element positioned in or in close proximity of a field plane allows to set a desired angular distribution individually for each point in the illuminated field on the reticle. In a step-and-scan projection exposure apparatus the third optical raster element has to be moved synchronously with the reticle in order to maintain a point-to-point correlation between points in the field plane, in which the third optical raster element is positioned, and corresponding points on the reticle.

The third optical raster element may be a diffractive optical element comprising a plurality of contiguous diffraction zones each adapted for diffracting light such that a pupil plane is only partially illuminated by a single zone. Preferably the areas in the pupil plane illuminated by the zones do not overlap. If the third optical raster element is not moved but fixed during a scan movement of the reticle, a point on the reticle will be illuminated successively by projection light having different angular distributions. To be more precise, if the extension of the zones in the scan direction is smaller than the illuminated field in the field plane in which the third optical raster element is positioned, then at least two different zones contribute to the illumination of the reticle. If the at least two zones generate projection light with different angular distributions, each point on the reticle is successively exposed to projection light that differs with respect to the angular distribution. A similar concept is as such known from U.S. Pat. No. 5,920,380 which is incorporated herein by reference.

Preferably, the zones of the third optical raster element have at least approximately the shape of elongated rectangles having a longitudinal axis that is arranged at least substantially perpendicular to a scan direction of the projection exposure apparatus. The diffraction angles into which light is diffracted by the zones may increase along a direction parallel to the scan direction.

This embodiment can be further improved if the third optical raster element extends above an illuminated field and is arranged so that it can be moved substantially along a scan direction. By moving the third optical raster element along the scan direction the angular distribution resulting on the reticle may be quasi-continuously modified.

According to another advantageous embodiment of the invention a polarization manipulator is positioned in close proximity to the third optical raster element. This allows to manipulate the polarization state of the projection light bundle. The polarization manipulator can, for example, be a linear polarizer or a polarization rotation device such as a waveplate.

In a preferred embodiment the polarization manipulator is positioned immediately in front of the third optical raster element. This has the advantage that the projection light has the desired polarization state before it enters the third optical raster element. Thus it is possible to adapt the polarization state generated by the polarization manipulator to the specific properties of the optical raster element. For example, if the third optical raster element is a linear diffraction grating, the polarization state can be manipulated such that the projection light passing through the polarization manipulator is linearly polarized along the longitudinal direction of the grooves. This, in turn, results in a tangential polarization of the projection light bundle. Tangential polarization has been found to be particularly advantageous because it results in improved contrast on the photoresist.

If the polarization state of the projection light impinging on the polarization manipulator is linear, the polarization manipulator may be realized as a polarization rotation device such as a waveplate that rotates the direction of polarization as desired. This has the advantage that no light is lost in the polarization manipulator. If the projection light is fully or partially unpolarized, the polarization manipulator may be realized as a linear polarizer.

If the third optical raster element comprises a plurality of optical sub-elements having a non-uniform distribution over an area of the raster element, it may be advantageous to use a polarization manipulator that has a locally varying polarization manipulating property, for example the ability to transmit only light having a selected polarization or to rotate the polarization direction. The polarization manipulator may thus be locally adapted to the third optical raster element.

### BRIEF DESCRIPTION OF THE DRAWINGS

An embodiment of the invention is described in detail below this reference to the drawings in which

FIG. 1 shows a meridional section through an illumination system according to a first embodiment of the present invention;

FIG. 2 shows schematically a convolution of two intensity distributions in pupil planes;

FIG. 3 shows schematically a convolution of two other intensity distributions in pupil planes;

FIG. 4 shows a part of an illumination system according to a second embodiment of the invention in a representation similar to FIG. 1;

FIG. 5 shows a schematic top view of a diffractive optical element to be positioned in a field plane of the illumination system shown in FIG. 4;

FIG. 6 shows a part of an illumination system according to a third embodiment of the invention in a representation similar to FIG. 1;

FIG. 7 shows schematically an enlarged partial view of a diffractive optical element to be positioned in a field plane of the illumination system shown in FIG. 6;

FIG. 8 schematically shows in a three-dimensional illustration a step-and-scan tool with a reticle illuminated by the illumination system as shown in FIG. 7;

FIG. 9 shows an alternative embodiment for the diffractive optical element illustrated in FIG. 7 that results in different illumination angel distributions in a direction perpendicular to a scan direction;

FIG. 10 schematically shows a step-and-scan tool similar to the tool shown in FIG. 8, but with the diffractive optical element illustrated in FIG. 9.

### DESCRIPTION OF PREFERRED EMBODIMENTS

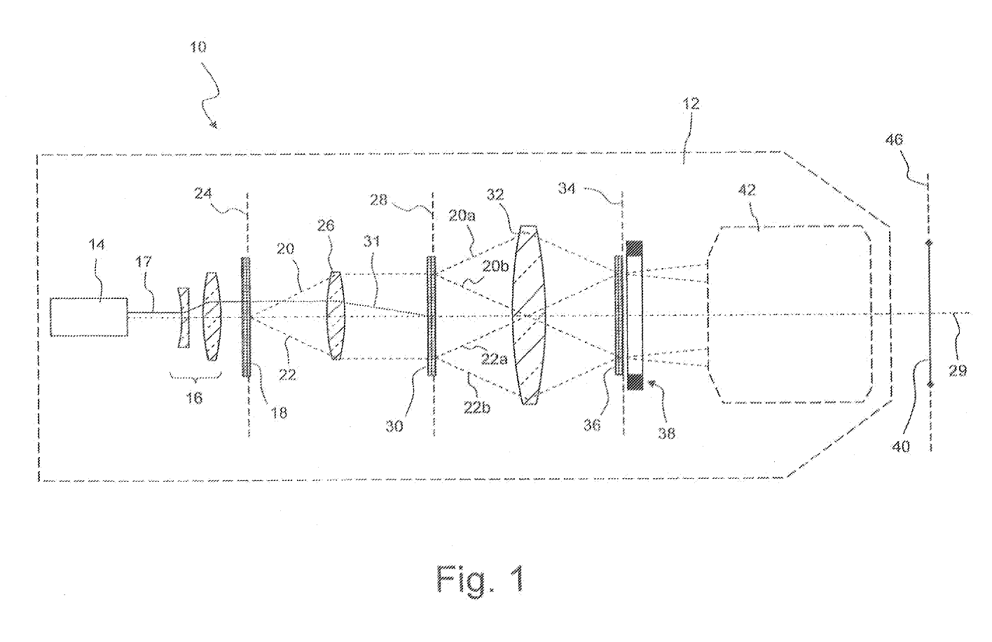

FIG. 1 shows a meridional section of an illumination system according to the present invention that is to be used in a projection exposure apparatus. For the sake of clarity, the illustration shown in FIG. 1 is considerably simplified and not to scale. The illumination system, which is denoted in its entirety by 10, comprises a light source that is, in the embodiment shown, realized as an excimer laser 14. The excimer laser 14 emits projection light that has a wavelength in the deep ultraviolet (DUV) spectral range. The projection light emerging from the exit facet of the laser 14 forms a coherent light bundle having a small cross section and a low divergence. Thus the geometrical optical flux of the light bundle as emitted by the laser 14 is small.

The light bundle then enters a beam expansion unit 16 in which the light bundle is expanded. In FIG. 1 this expansion is represented by a ray 17 of the light bundle. Since the ray 18 is diverted at refractive interfaces, the cross section of the light bundle is increased without altering the geometrical optical flux of the bundle. This is due to the fact that the geometrical optical flux is an invariable quantity for light bundles that are refracted at interfaces between optical media having differing indices of refraction.

After passing through the beam expansion unit 16 the projection light bundle impinges on a first optical raster element which is, in the embodiment shown, a diffractive optical element 18. The first diffractive optical element 18 comprises one or more diffraction gratings that deflect each impinging ray such that a divergence is introduced. In FIG. 1 this is schematically represented for an axial ray that is split into two diverging rays 20, 22. The first diffractive optical element 18 thus modifies the angular distribution of the projection light bundle and also enlarges its geometrical optical flux. Since diffractive optical elements of this kind that are suited for this purpose are known in the art as such, see for example U.S. Pat. No. 6,285,443, the first diffractive optical element will not be described in further detail below.

The first diffractive optical element 18 can also be replaced by any other kind of optical raster element, for example a micro-lens array in which the micro-lenses are formed by Fresnel zone plates. Other examples for optical raster elements that are suitable for this purpose are given in the aforementioned U.S. Pat. No. 6,285,443.

The first diffractive optical element 18 is positioned in an object plane 24 of a first objective 26 that is represented in FIG. 1 by a single positive lens. Reference numeral 28 denotes an exit pupil plane of the first objective 26. If the first diffractive optical element were not present, the ray 18 would be a principal ray that crosses the optical axis 29 of the illumination system 10 in the pupil plane 28. In FIG. 1 such an imaginary ray is represented by a dotted line 31.

A second diffractive optical element 30 is positioned in the pupil plane 28 of the first objective 26. The second diffractive optical element 30 again introduces a divergence for each point and thus enlarges the geometrical optical flux of the projection light bundle a second time. Again, the diffractive optical element 30 may be any kind of optical raster element in the sense as mentioned above. The divergence introduced by the second diffractive optical element 30 is schematically represented in FIG. 1 by divergent rays 20a, 20b and 22a, 22b for the impinging rays 20 and 22.

The diverging rays 20a, 20b and 22a, 22b enter a second objective 32 that is represented in FIG. 1 by a single condenser lens 32. The second objective 32 is arranged within the illumination system 10 such that its entrance pupil plane coincides with the exit pupil plane 28 of the first objective 26. The image plane 34 of the second objective 32 is a field plane in which a third diffractive optical element 36 and a reticle masking (REMA) unit 38 are positioned. The third diffractive optical element 36 again introduces an additional divergence and thus increases the geometrical optical flux of the projection light bundle.

The reticle masking unit 38 comprises two pairs of opposing blades. These blades form an aperture stop that determines the geometry of the illuminated field on a reticle 40 through which the projection light bundle finally passes. Two this end, a third objective 42 having an object plane that coincides with the image plane 34 of the second objective is arranged along the optical axis 29 of the illumination system 10. In an image plane 46 of the third objective 42, which is also referred to as REMA objective, the reticle 40 is positioned.

Since the geometrical optical flux has been increased by the first diffractive optical element 18 by a comparatively small degree, the first objective 26 can be designed in a fairly simply manner, for example without the need to incorporate aspheric lenses or lenses having very large diameters. For this reason the lens representing the first objective 26 has been drawn smaller than the lens representing the second objective 32. However, also the second objective 32 can be realized with moderate expenses because the maximum geometrical optical flux is only achieved behind the third diffractive optical element 36.

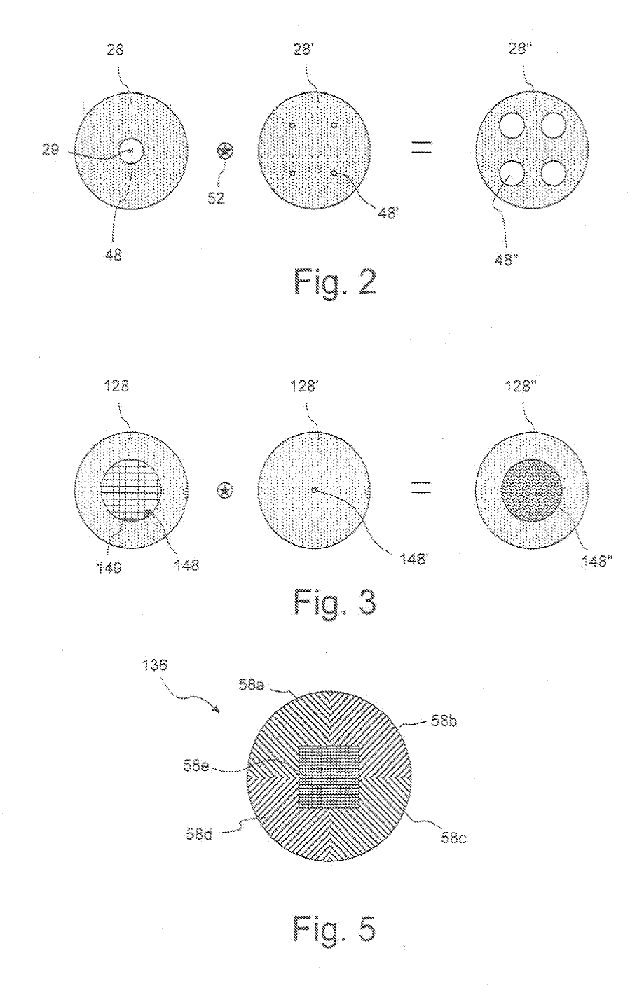

In the following the function of the illumination system 10 is explained in more detail with reference to FIG. 2 which shows a convolution of two intensity distributions in pupil planes generated by the first and the third diffractive optical elements 18 and 36, respectively. In FIG. 2 the pupil plane 28 is represented as disc that is dotted in those areas in which no light traverses the pupil plane 28. It is now assumed that the first diffractive optical element 18 is configured in such a way that only a small circular area 48 is illuminated in the pupil plane 28. Since the image plane 34 is a field plane conjugated by Fourier transformation to the pupil plane 28, all rays that are incident on the image plane 34 under a certain angle of incidence traverse the pupil plane 28 at the same radial distance from the optical axis 29. The intensity distribution in the pupil plane 28 therefore determines the angular distribution of the projection light bundle in the image plane 34 before it impinges on the third diffractive optical element 36.

Since the first and the second objective 42 do not alter the geometrical optical flux, the angular distribution of the projection light bundle is only determined by the first and the third diffractive optical elements 18, 36 that are positioned in or in close proximity to planes that are conjugated to the pupil plane 28 by Fourier transformation. The second diffractive optical element positioned in the pupil plane 28 does not alter the angular distribution but, in turn, determines the spatial distribution of the projection light bundle in the image plane 34 and thus on the reticle 40.

Mathematically the contributions of the first and the third optical elements 18, 36 to the angular distribution of the projection light bundle can be described as a convolution of the intensity distributions in pupil planes generated by each of the diffractive optical elements 18, 36. In the embodiment shown in FIGS. 1 and 2 it is assumed that the first diffractive optical element 36 is configured in such a way that it directs a bundle of impinging parallel light into a single circular spot 48 centered within the pupil plane 28. The third diffractive optical element 36 is assumed to be configured in such a way that it directs a bundle of impinging parallel light into to four small spots 48′ distributed over an imaginary pupil plane 28′.

In order to determine the intensity distribution in a pupil plane illuminated by both the first and the third diffractive optical elements 18, 36, the intensity distributions in the pupil planes 28, 28′ have to be convoluted which is indicated in FIG. 2 by a symbol 52. The result of the convolution is shown in FIG. 2 on the right side which shows a pupil plane 28″ in which four spots 48″ are illuminated that differ from the spots 48′ in the pupil plane 28′ in that each spot 48″ has the size of the area 48 illuminated in the pupil plane 28. As a result, the projection light bundle emerging from the third diffractive optical element 36 has an angular distribution that can be represented in a conjugated pupil plane 28″ by the intensity distribution as shown in FIG. 2 on the right side. This particular intensity distribution is usually referred to as quadrupole illumination. By providing two diffractive optical elements 18, 36 in planes conjugated by Fourier transformation to the pupil plane 28, it is thus possible to generate a very wide variety of different angular distributions for the projection light bundle.

In the embodiment shown in FIG. 3 the diffractive optical elements 18, 36 are configured in a manner different from the embodiment shown in FIG. 2. The first diffractive optical element 18 illuminates in the pupil plane 28 an area 148 that has, as compared with area 48 as shown in FIG. 2, a larger diameter. Furthermore, the area 148 is not uniformly illuminated but is constituted by a plurality of sub-areas 149 that are arranged in a grid-like manner. The sub-areas 149 are slightly spaced apart so that the area 148 contains a grid that is not illuminated by projection light. This grid of non-illuminated portions in the area 148 corresponds to missing illumination angles in the projection light bundle impinging on the reticle 40 which is an undesired effect. The geometry of the grid is only exemplarily shown in FIG. 3 for the sake of simplicity; in reality the shape of the sub-areas 149 and thus of the grid that is not illuminated may be different. Generally this shape depends on the kind of raster element that is positioned in the object plane 24.

In the embodiment shown in FIG. 3 the third diffractive optical element 36 is replaced by a raster element in a form of a scattering plate that scatters impinging light in arbitrary directions within a small scattering angle range. Therefore a small spot 148′ is almost uniformly filled with projection light in an imaginary pupil plane 128′. Convolution of the two intensity distributions in the pupil planes 28, 28′ results in an intensity distribution in which an area 148″ having the shape of the area 148 in the pupil plane 28 is illuminated by the projection light as scattered by the scattering plate. The grid of non-illuminated portions within the area 148 is therefore not present in the resulting intensity distribution.

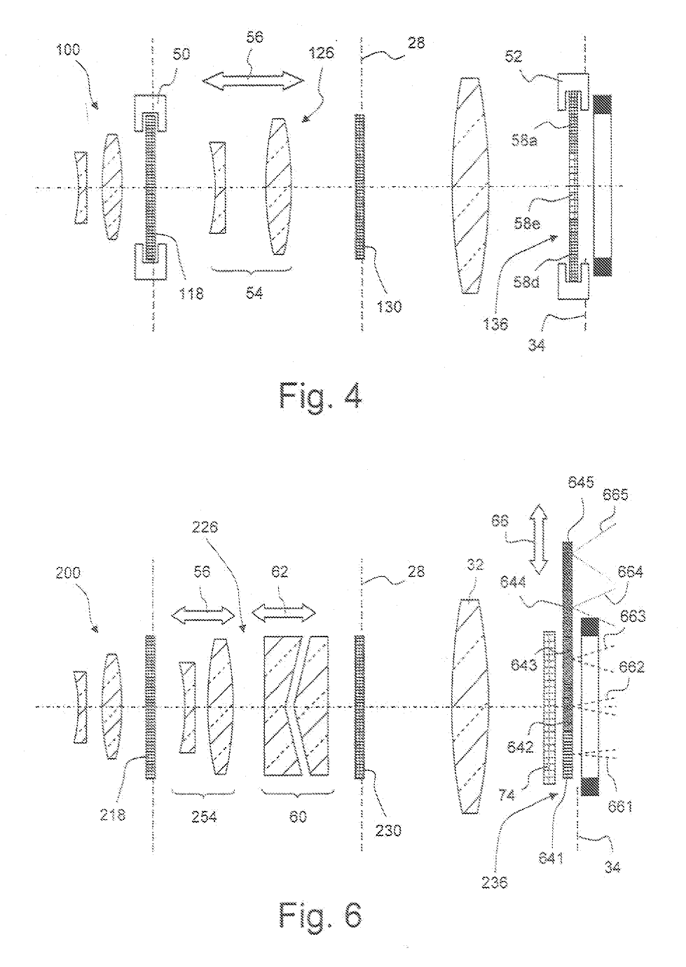

FIG. 4 shows another embodiment of an illumination system in a representation similar to FIG. 1, but without the laser 14, the third objective 42 and the reticle 40. In this embodiment of an illumination system which is denoted in its entirety by 100, a first and a third diffractive optical element 118, 136 are each received in holders 50 and 52, respectively, that allow to easily replace the diffractive optical elements 118, 136, by other optical raster elements. It is thus possible to modify the angular distribution of the projection light by simply replacing one or both of these elements.

In addition, the illumination system 100 comprises a first objective 126 between the first and the second diffractive optical elements 118, 130 containing a zoom unit 54 as is known in the art as such. By moving one ore more lenses of the zoom unit 54 along a direction indicated by an arrow 56, it is possible to change the size of the areas illuminated in the pupil plane 28. This introduces an additional degree of freedom for manipulating the angular distribution of the projection light bundle.

The third diffractive optical element 136 comprises five zones 58a, 58b, 58c, 58d and 58e each containing a different diffraction grating. The arrangement of the zones 58a to 58e is shown in the top view of FIG. 5. Since the third diffractive optical element 136 is imaged onto the reticle 40 by the third objective 42, each point on the diffractive optical element 136 corresponds to exactly one point on the reticle 40. Of course, this holds true only in stepper tools in which the reticle 40 does not move during exposure. In the case of a step-and-scan tool, the third diffractive optical element 136 has to be synchronously moved within the plane 34 in order to maintain the correlation between points on the third diffractive optical element 136 on the one hand and points on the reticle 40 on the other hand.

If the different zones 58a to 58e produce different angular distributions, the angular distribution of projection light impinging on a particular point on the reticle 40 depends on the zone in which the corresponding point in the field plane 34 is situated. The third diffractive optical element 136 thus allows to manipulate the angular distribution of the projection light selectively for each point on the reticle 40. This can be particularly useful if the pattern contained in the reticle 40 comprises areas of differently sized structures. By defining appropriate zones 58a to 58e on the third diffractive optical element 136, it is thus possible to generate a projection light bundle that has individually optimized angular distributions for these differently patterned areas on the reticle.

FIG. 6 shows a further embodiment of an illumination system which is denoted in its entirety by 200. A first objective 226 between first and second diffractive optical elements 218, 230 comprises a zoom unit 254 and, in addition, a pair of axicon lenses or prisms whose spacing in the direction of the optical axis 29 can be changed by moving one or both axicon lenses along the optical axis 29 (see arrow 62). The pair 60 of axicon lenses is particularly suited for generating an annular intensity distribution in the pupil plane 28. Since axicon lenses as such are known in the art for the purpose of modifying the angular distribution of light, the pair 60 of axicon lenses will not be described in further detail in this context.

In the image plane 34 of the second objective 32 a third diffractive optical element 236 is positioned that comprises n zones 641, 642, . . . , 64n each containing a diffraction grating that diffracts incoming light into different directions. For the sake of clarity, only five zones 641 to 645 are shown in FIG. 6. In reality, the diffractive optical element 236 may comprise considerably more zones, for example several hundred zones. Further details of a similar diffractive optical element are disclosed in U.S. Pat. No. 5,920,380 whose contents are incorporated herein by reference.

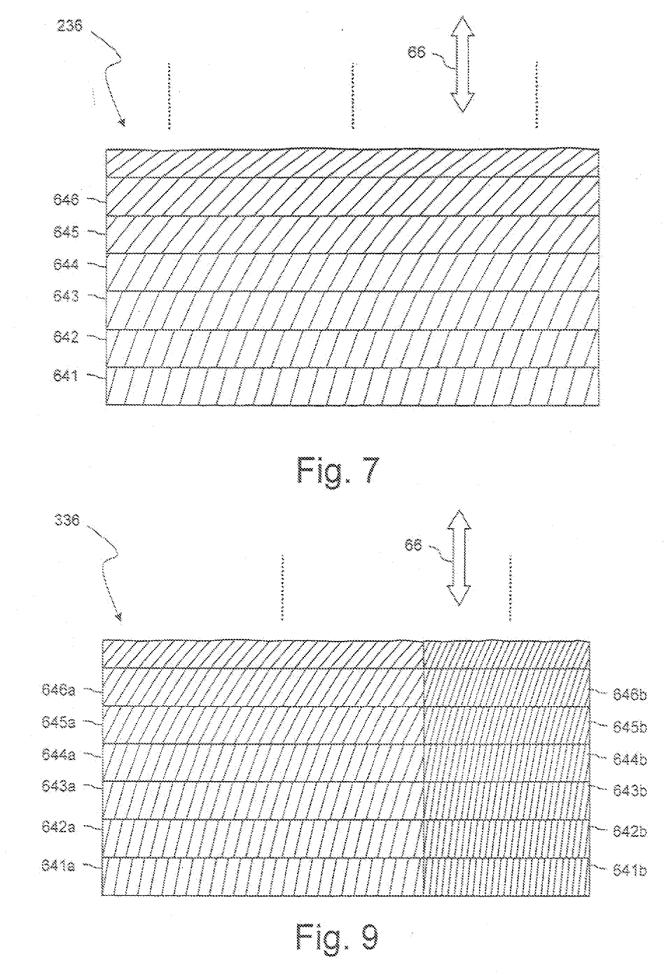

FIG. 7 shows a top view of the third diffractive optical element 236 illustrating the geometry and arrangement of the zones 641 to 64n. The zones 641 to 64n have the shape of elongated rectangular stripes, each of which containing a different diffraction grating. The zones 641 to 64n are arranged in such a way that the adjacent longitudinal sides of the zones are oriented perpendicularly to a scan direction in which the reticle 40 is moved on a stage within the image plane of the third objective 42. The scan direction is indicated in FIGS. 6 and 7 by arrows 66. The diffraction gratings contained in each of the zones 641 to 64n are configured such that the diffraction angle increases along the scan direction 66 from 0° to a maximum diffraction angle αₘₐₓ. In FIG. 7 this property of the diffraction gratings is indicated by different hatches within each of the zones 641 to 64n; in FIG. 6 this property is indicated by pairs of rays 661 to 665 emerging from the zones 641 to 645 under different angles.

In the simplified representation of FIG. 6, the projection light bundle traverses only three adjacent zones 641, 642, 643. If the reticle 40 is assumed to be fixed in the image plane 46 of the third objective 42, then there would be three different areas on the reticle 40 on which projection light with different angular distributions impinge. Thus there would be a situation similar to what has been explained before with reference to the illumination system shown in FIG. 4.

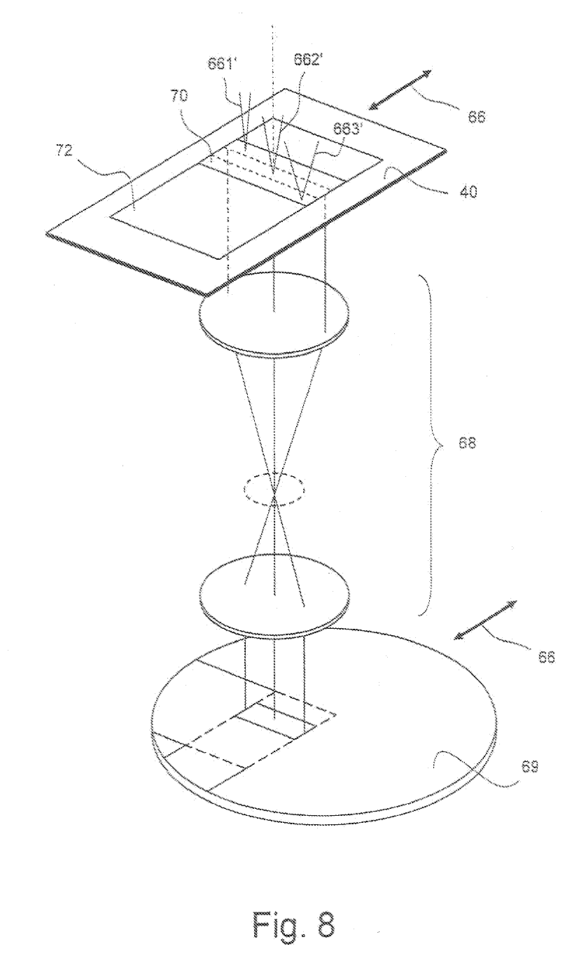

If, however, there is a relative movement between the reticle 40 and the third diffractive element 236 along the scan direction 66, each point on the reticle 40 will be successively exposed to a projection light having a different angular distribution. This is schematically illustrated in FIG. 8 which shows in a perspective schematic view how a pattern contained in a reticle 40 is imaged by a projection lens 68 onto a wafer 69 covered with a photoresist. While the reticle 40 is moved along the scan direction 66, an illumination field 70 in the form of a rectangular slit scans a patterned area 72 on the reticle 40. Since the projection light bundle that illuminates the field 70 has traversed three different zones of the third diffractive optical element 236, there is a corresponding number of zones within the illuminated field 70 that differ with respect to the angular distribution of the impinging projection light.

In FIG. 8 this is indicated by rays 661′ to 663′ that correspond to the rays 661 to 663 shown in FIG. 6. While the reticle 40 is moved along the scan direction 66, each point within the patterned area 72 is exposed successively to projection light having a different angular distribution. As a result, the different angular distributions integrate on the time scale during the scan process so that each point on the patterned area 72 will have been traversed by projection light of all angular distributions that have been generated by the zones 641 to 643 of the third diffractive optical element 236.

As can be seen in FIG. 6, the extension of the third diffractive optical element 236 in the scan direction 66 is considerably larger than the extension of the projection light bundle in this direction. By moving the third diffractive optical element 236 along the scan direction 66, it is thus possible to have the projection light bundle pass through different sections of the third diffractive optical element 236. For example, if the third diffractive optical element 236 is moved downward in FIG. 6, the zones 644 and 645, which contain diffraction gratings that result in larger diffraction angles, will successively be shifted into the illuminated field. Simultaneously the zones 641 and 642 will be removed from the illuminated field.

By moving the third diffractive optical element 236 in the scan direction 66 it is thus possible to quasi-continuously change the resulting angular distribution of the projection light that impinges on each point on the patterned area 72 during the exposure. If the diffraction angles of the diffraction gratings within the zones 641 to 64n successively increase as has been explained above, it is possible to alter the illumination setting from a conventional setting in which illumination angles between 0° and αₘₐₓ are present, to an annular illumination setting in which only illumination angles between values α₁≠0 and α₂ are present. The pair 60 of axicon lenses may then be dispensed with. The smaller the difference between diffraction angles of adjacent zones are, the more continuous will be the transition between different illumination settings that can be achieved by moving the third diffractive optical element 236 in the scan direction 66.

If the zones 641 to 64n are arranged along the scan direction 66 in a different order, i.e. not with continuously increasing diffraction angles, quasi-continuous transitions between illumination settings other than conventional and annular settings may be achieved.

Optionally a waveplate 74 may be positioned immediately in front of the third diffractive optical element 236. The waveplate 74 is configured in such a way that projection light impinging on the diffraction gratings contained in the zones 641 to 64n is linearly polarized along the longitudinal direction of the grooves of the gratings. Since the laser 14 emits linearly polarized light, it is sufficient to rotate the polarization direction such that the aforementioned condition is fulfilled. If the projection light is not linearly polarized but fully or partially unpolarized, for example, the waveplate 74 has to be replaced by a linear polarizer.

Said condition results in a tangential polarization of the projection light, i.e. the projection light traversing the reticle 40 and finally converging on the photoresist is polarized such that for all rays, independent of the azimuth angle and the angle of incidence, the light is polarized perpendicularly to the plane of incidence (s-polarization). This, in turn, results in an improved contrast, because tangential polarization enables perfect constructive and destructive interference in the image plane of the projection lens.

If the directions of the grooves within the diffraction gratings of the zones 641 to 64n are different, the polarization state of projection light impinging on the third diffractive optical element 236 has to be manipulated accordingly. It may thus be required that the waveplate 54 rotates the polarization state by different angles. This can be achieved by providing a waveplate 74 which has a varying thickness across its area. The provision of the waveplate 74 or any other polarization manipulator in front of the third diffractive optical element 236 therefore allows to produce projection light in which the state of polarization depends on the illumination angle. This is particularly advantageous if the reticle 40 contains very complex patterns, for example assist features or phase objects. Additionally, undesired polarization dependent effects caused by diffraction at the reticle may be avoided.

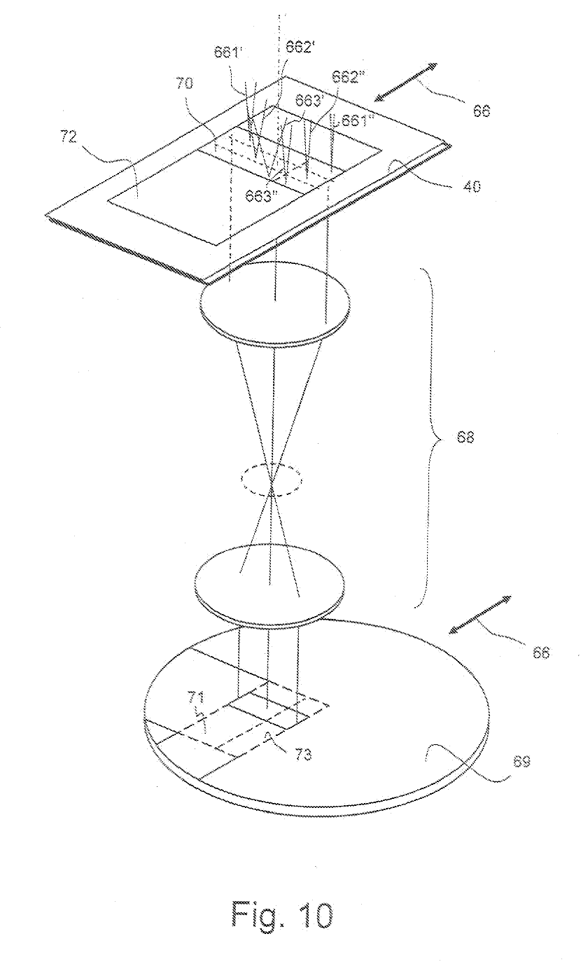

FIG. 9 shows an alternative embodiment for a third diffractive optical element that is similar to the one illustrated in FIG. 7 and may also be used in the illumination system 200 of FIGS. 6 and 8. In contrast to the third diffractive optical element 236 of FIG. 7, the third diffractive optical element 336 of FIG. 9 comprises not only one but two rows of diffraction zones denoted by 641a to 64na and 641b to 64nb, respectively. Both rows are aligned in parallel to the scan direction 66 and produce different integral angular distributions of projection light during the scan movement. Consequently, as is shown in FIG. 10 that corresponds to FIG. 8, the exposed area on the wafer 69 is separated into two stripes 71, 73 that differ with respect to the angular distributions to which they are integrally exposed during the scan movement. In FIG. 8 it is assumed that the angular distribution of the stripe 73, which corresponds to the zones 641b to 64nb, is similar to the distribution within stripe 71, but shifted to smaller angels. This is illustrated by rays 661″ to 663″ impinging on the patterned area 72.

Thus each row of zones 641a to 64na and 641b to 64nb is comparable to a single zone 58a to 58e of the third diffractive optical element 136 as shown in FIGS. 4 and 5. The only substantial difference is that said rows are subdivided into the sub-zones along the scan direction 66 for achieving the integrating effect mentioned above. Of course, the embodiment of FIG. 9 can only produce parallel stripes of different angular distributions on the wafer 69, whereas the third diffractive optical element 136 of FIGS. 4 and 5 allows to produce an arbitrary pattern of areas being exposed to different angular distributions.

1. An illumination system for a microlithographic projection exposure apparatus, comprising:
a) a light source,
b) a first optical raster element positioned in or in close proximity to a first plane that is conjugated to a pupil plane of the illumination system by Fourier transformation,
c) a second optical raster element positioned in or in close proximity to the pupil plane,
d) a third optical raster element positioned in or in close proximity to a second plane conjugated to the pupil plane by Fourier transformation.

2. The illumination system of claim 1, wherein the first optical raster element is positioned in or in close proximity to an object plane of a first objective, and wherein the second optical raster element is positioned in or in close proximity to an exit pupil plane of the first objective.

3. The illumination system of claim 1, wherein the second optical raster element is positioned in or in close proximity to an entrance pupil plane of a second objective, and wherein the third optical raster element is positioned in or in close proximity to an image plane of the second objective.

4. The illumination system of claim 2, wherein the first objective comprises an optical zoom unit for changing the size of an intensity distribution in the pupil plane generated by the first optical raster element.

5. The illumination system of claim 2, wherein the first objective comprises a pair of axicon lenses for changing the intensity distribution in the pupil plane generated by the first optical raster element.

6. The illumination system of claim 1, comprising a holder for interchangeably holding the first optical raster element.

7. The illumination system of claim 1, comprising a holder for interchangeably holding the third optical raster element.

8. The illumination system of claim 1, wherein the second optical raster element is a diffractive optical element or a micro-lens array.

9. The illumination system of claim 1, wherein the first and the third optical raster elements are diffractive optical elements.

10. The illumination system of claim 1, wherein the third optical raster element is a scattering screen.

11. The illumination system of claim 1, wherein the third optical raster element comprises a plurality of optical sub-elements having a non-uniform distribution over an area of the third raster element.

12. The illumination system of claim 11, wherein the third optical raster element is a diffractive optical element comprising a plurality of contiguous diffraction zones each adapted for diffracting light such that a pupil plane is only partially illuminated by a single zone.

13. The illumination system of claim 12, wherein the zones have at least approximately the shape of elongated rectangles having a longitudinal axis that is arranged at least substantially perpendicular to a scan direction of the projection exposure apparatus.

14. The illumination system of claim 13, wherein the diffraction angles into which light is diffracted by the zones increase along a direction parallel to the scan direction.

15. The illumination system of claim 13, wherein the third optical raster element extends beyond an illuminated field and is arranged so as to be movable substantially along a scan direction.

16. The illumination system of claim 1, wherein a polarization manipulator is positioned in close proximity to the third optical raster element.

17. The illumination system of claim 16, wherein the polarization manipulator is positioned immediately in front of the third optical raster element.

18. The illumination system of claim 16, wherein the third optical raster element is a diffraction grating having grooves that extend along a longitudinal direction, and wherein the polarization manipulator is adapted so that light traversing the polarization manipulator is linearly polarized along the longitudinal direction of the grooves.

19. The illumination system of claim 16, wherein the polarization manipulator is a linear polarizer.

20. The illumination system of claim 16, wherein the polarization manipulator is a polarization rotation device.

21. The illumination system of claim 16, wherein the polarization manipulator has a locally varying polarization manipulating property.

22. The illumination system of claim 21, wherein the polarization manipulator is a waveplate that has a locally varying thickness distribution across its area.

23. An illumination system for illuminating a reticle with projection light in a microlithographic projection exposure apparatus, said illumination system producing different angular distributions of projection light on at least two distinct points on the reticle.

24. A projection exposure apparatus comprising the illumination system of claim 1.

25. A projection exposure apparatus comprising the illumination system of claim 23.

26. A microlithographic method of fabricating a microstructured device, comprising the following steps:
a) providing a substrate supporting a light sensitive layer;
b) providing a reticle containing structures to be imaged onto the light sensitive layer;
c) providing the illumination system of claim 1;
d) projecting at least a part of the reticle onto the light sensitive layer.

27. A microlithographic method of fabricating a microstructured device, comprising the following steps:
a) providing a substrate supporting a light sensitive layer;
b) providing a reticle containing structures to be imaged onto the light sensitive layer;
c) illuminating the reticle such that at least two distinct points on the reticle are illuminated with projection light having different angular distributions;
d) projecting at least a part of the reticle onto the light sensitive layer.

28. A microstructured device which is fabricated in accordance with the method of claim 26.

29. A microstructured device which is fabricated in accordance with the method of claim 27.
